(19) United States
(12) Patent Application Publication
(10) Pub. No.: US 2014/0061972 A1
(43) Pub. Date: Mar. 6, 2014

(54) MICROTITER PLATES AND METHODS OF USE

(71) Applicant: BIOTIX, INC., San Diego, CA (US)

(72) Inventor: Arta MOTADEL, San Diego, CA (US)

(73) Assignee: BIOTIX, INC., San Diego, CA (US)

(21) Appl. No.: 14/075,898

(22) Filed: Nov. 8, 2013

Related U.S. Application Data
(63) Continuation of application No. 13/281,344, filed on Oct. 25, 2011.

(51) Int. Cl. B01L 3/00

(52) U.S. Cl. CPC B01L 3/5085
USPC 264/322

(57) ABSTRACT

Described herein are polymer low profile microtiter plates suitable for use in a variety of laboratory and clinical settings. The microtiter plates described herein also are compatible with automated or manual liquid dispensing devices and high throughput robotic biological work stations.

### RELATED PATENT APPLICATIONS

This patent application is a continuation of U.S. patent application Ser. No. 13/281,344, filed Oct. 25, 2011, entitled MICROTITER PLATES AND METHODS OF USE, naming Arta MOTADEL as inventor, and designated by attorney docket no. PEL-1012-UT. The entirety of this patent application is incorporated herein by reference.

### FIELD

The technology relates in part to multiwell liquid handling devices and methods for using them.

### BACKGROUND

Microtiter plates (also referred to as microplates and microwell plates) generally are a substantially flat plate with multiple wells arranged in an array. Microtiter plates can be configured with from about 6 to about 9600 wells. Microtiter plates have multiple uses including but not limited to holding and transporting liquids, performing biological or chemical reactions, combinations thereof and the like. Microtiter plates frequently are used in research or diagnostic procedures including high throughput protocols.

### SUMMARY

Provided herein in certain embodiments is a microtiter plate that comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are in the range of about 0.001 to 0.020 inches thick, with a variance of +/−15%. That is, the plate, sidewalls, well wall and well bottom are in the range of about 0.00085 to 0.023 inches thick, in certain embodiments. In some embodiments the plate, sidewalls, well wall and well bottom wall thickness is measured post-manufacture.

Also provided herein in certain embodiments is a microtiter plate prepared by a process that comprises contacting a mold with a polymer sheet and deforming the sheet on the mold, whereby a microtiter plate is formed from the sheet where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick.

Also provided herein in certain embodiments is a process for preparing a microtiter plate that comprises contacting a mold with a polymer sheet and deforming the sheet on the mold, whereby a microtiter plate is formed from the sheet where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick.

Also provided herein in certain embodiments is a method for manipulating a reagent in a microtiter plate that comprises introducing a reagent to a microtiter plate and removing the reagent from the microtiter plate, where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick.

Also provided herein in certain embodiments is a method for measuring the optical transmittance of a sample liquid in a microtiter plate that comprises contacting a microtiter plate containing the sample liquid with light and measuring the amount of light transmitted through the sample liquid using a suitable light measurement device (e.g., microtiter plate reader), where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick. In some embodiments, a reference standard liquid can be utilized to determine the amount of light transmitted though the sample liquid. In certain embodiments, the polymer used is treated to enhance the ability to measure light transmittance. In some embodiments the light is measured as fluorescence.

Also provided herein in certain embodiments is a method for measuring the optical absorbance of a sample liquid in a microtiter plate that comprises contacting a microtiter plate containing the sample liquid with light and measuring the amount of light absorbed by the sample liquid using a suitable light measurement device (e.g., microtiter plate reader), where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick. In some embodiments, a reference standard liquid can be utilized to determine the amount of light absorbed by the sample liquid. In certain embodiments, the polymer used is treated to enhance the ability to measure light absorbance. In some embodiments the light is measured as fluorescence.

In some embodiments, the plate and sidewalls of microtiter plates described herein are coextensive. In certain embodiments, the plate and wells are coextensive. In some embodiments, the well wall and well bottom are coextensive. In certain embodiments, well walls sometimes are touching. In some embodiments, the sidewall bottom edge and/or sidewall flange are coplanar with the well base outer surface.

In some embodiments, the well cross-sectional shape is chosen from a circle, a square, a triangle, or a polygon. In certain embodiments, the well bottom is flat. In some embodiments, the well bottom is round. In certain embodiments, the well bottom is stepped. In some embodiments, the well bottom is an inverted cone, and in certain embodiments the well bottom is a V-shape.

Microtiter plates described herein often are compatible with high throughput procedures and/or robotic biological workstations. In certain embodiments, microtiter plates described herein further comprise four sidewalls, and the sidewall bottom edges form a footprint configured to contact an automated dispensing device. In some embodiments, the sidewalls comprise a substantially vertical surface. In certain embodiments, the sidewall edges comprise a flange angled with respect to the base of the sidewalls, and in some embodiments the sidewall flange angle is about 90 degrees with respect to the base of the sidewalls.

In certain embodiments, microtiter plates described herein have a sidewall height in the range of about 0.30 inches to about 0.50 inches. In some embodiments, microtiter plates described herein have a well depth in the range of about 0.24 inches to about 0.30 inches. In certain embodiments, the sidewall height to plate width ratio is in the range of about 0.05 to about 0.20. Microtiter plates described herein can be configured with between about 6 to 6144 wells in some embodiments, and in certain embodiments microtiter plates described herein can have up to 9600 wells. In some embodiments, microtiter plates described herein comprise 96 wells, and the wells have a volume in the range of about 175 to about 225 microliters, in certain embodiments. In some embodiments with 96 wells, each well has a well aperture diameter in the range of about 0.265 inches to about 0.320 inches. In certain embodiments, the wells further comprise a well center to well center distance in the range of about 0.340 inches to about 0.360 inches. In some embodiments, the wells have a well depth to well diameter ratio in the range of 0.50 to about 1.75.

In some embodiments, microtiter plates described herein comprise 384 wells, and the wells have a volume in the range of about 10 microliters to about 90 microliters, in certain embodiments. In some embodiments with 384 wells, each well has a well aperture diameter in the range of about 0.130 inches to 0.165 inches. In certain embodiments, the wells further comprise a well center to well center distance in the range of about 0.160 inches to about 0.180 inches. In some embodiments, the wells have a well depth to well diameter ratio in the range of about 0.70 to about 1.15.

In some embodiments, microtiter plates described herein comprise 1536 wells, and the wells have a volume in the range of about 2 microliters to about 8 microliters, in certain embodiments. In some embodiments with 1536 wells, each well has a well aperture diameter in the range of about 0.060 inches to 0.080 inches. In certain embodiments, the wells further comprise a well center to well center distance in the range of about 0.085 inches to about 0.095 inches. In some embodiments, the wells have a well depth to well diameter ratio in the range of about 0.70 to about 1.15.

In some embodiments, microtiter plates described herein comprise 6144 wells, and the wells have a volume in the range of about 1 microliters to about 4 microliters, in certain embodiments. In some embodiments with 6144 wells, each well has a well aperture diameter in the range of about 0.030 inches to 0.040 inches. In certain embodiments, the wells further comprise a well center to well center distance in the range of about 0.040 inches to about 0.050 inches. In some embodiments, the wells have a well depth to well diameter ratio in the range of about 0.70 to about 1.15.

In certain embodiments, the polymer is selected from polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystryrene, acrylnitrile butadiene styrene copolymers, crosslinked polysiloxanes, polyurethanes, (meth)acrylate-based polymers, cellulose and cellulose derivatives, polycarbonates, ABS, tetrafluoroethylene polymers, plastics with higher flow and lower viscosity, a combination of two or more of the foregoing, corresponding copolymers and the like. In some embodiments, the polymer is a biodegradable polymer. In certain embodiments, the biodegradable polymer is selected from (a) naturally-occurring polymers consisting of polysaccharides (e.g., starch and the like); (b) microbial polyesters that can be degraded by the biological activities of microorganisms (e.g., polyhydroxyalkanoates and the like); (c) conventional plastics mixed with degradation accelerators (e.g., mixtures having accelerated degradation characteristics such as photosensitizers); and (d) chemosynthetic compounds (e.g., aliphatic polyesters and the like).

Certain embodiments are described further in the following description, examples, claims and drawings.

### BRIEF DESCRIPTION OF THE DRAWINGS

The drawings illustrate embodiments of the invention and are not limiting. For clarity and ease of illustration, the drawings are not made to scale and, in some instances, various aspects may be shown exaggerated or enlarged to facilitate an understanding of particular embodiments.

Certain features common to some or all the figures (e.g., FIG., or FIGS.) presented herein are identified by a prime symbol (′) after the reference character. For example a feature labeled 14 in one drawing and substantially similar or substantially identical to a feature in one or more additional drawings, would be labeled 14′ in the second and subsequent drawings. In instances where a figure is not explicitly described, but contains reference characters containing the prime symbol (′), it will be understood the description given for the reference character in one figure, will be substantially identical for the reference character with the prime symbol.

FIGS. 1-8 illustrate a 96 well microtiter plate embodiment as described herein. FIG. 1 shows a top perspective view of a 96 well microtiter plate embodiment. FIG. 2 shows a short or width side view of a 96 well microtiter plate embodiment. FIG. 3 shows cross-section view of a 96 well microtiter plate embodiment taken along line 3 illustrated in FIG. 1. The cross section illustrated in FIG. 3 is a view along the short or width side of the microtiter plate. FIG. 4 shows a cross-section view of a 96 well microtiter plate embodiment taken along line 4 illustrated in FIG. 1. The cross section illustrated in FIG. 4 is a view along the long or length side of the microtiter plate. FIG. 5 shows a top view of a 96 well microtiter plate embodiment. FIG. 6 shows a long or length side view of a 96 well microtiter plate embodiment. FIG. 7 shows a bottom view of a 96 well microtiter plate embodiment. FIG. 8 shows a perspective view of a 96 well microtiter plate embodiment configured with optional corner detents or cut outs. The optional cut outs sometimes are used to help immobilize the microtiter plate in a holder or robotic device. The optional cut outs sometimes also help prevent nesting when stacked. The optional cut outs shown in FIG. 8 sometimes also are configured on other microtiter plate embodiments described herein (e.g., 384 well plates, 1536 well plates).

FIGS. 9-15 illustrate a 384 well microtiter plate embodiment as described herein. FIG. 9 shows a top perspective view of a 384 well microtiter plate embodiment. FIG. 10 shows a short or width side view of a 384 well microtiter plate embodiment. FIG. 11 shows cross-section view of a 384 well microtiter plate embodiment taken along line 3 illustrated in FIG. 9. The cross section illustrated in FIG. 11 is a view along the short or width side of the microtiter plate. FIG. 12 shows a cross-section view of a 384 well microtiter plate embodiment taken along line 4 illustrated in FIG. 9. The cross section illustrated in FIG. 12 is a view along the long or length side of the microtiter plate. FIG. 13 shows a top view of a 384 well microtiter plate embodiment. FIG. 14 shows a long or length side view of a 384 well microtiter plate embodiment. FIG. 15 shows a bottom view of a 384 well microtiter plate embodiment.

FIGS. 16-22 illustrate a 1536 well microtiter plate embodiment as described herein. FIG. 16 shows a top perspective view of a 1536 well microtiter plate embodiment. FIG. 17 shows a short or width side view of a 1536 well microtiter plate embodiment. FIG. 18 shows cross-section view of a 1536 well microtiter plate embodiment taken along line 3 illustrated in FIG. 16. The cross section illustrated in FIG. 18 is a view along the short or width side of the microtiter plate. FIG. 19 shows a cross-section view of a 1536 well microtiter plate embodiment taken along line 4 illustrated in FIG. 16. The cross section illustrated in FIG. 19 is a view along the long or length side of the microtiter plate. FIG. 20 shows a top view of a 1536 well microtiter plate embodiment. FIG. 21 shows a long or length side view of a 1536 well microtiter plate embodiment. FIG. 22 shows a bottom view of a 1536 well microtiter plate embodiment.

### DETAILED DESCRIPTION

Microtiter plates described herein often are used in conjunction with high throughput automated procedures, and are therefore designed and manufactured with a sidewall bottom edge footprint configured to contact an automated dispensing device, in certain embodiments. That is, microtiter plates described herein sometimes conform to some or all of the American National Standards Institute (ANSI) standard dimensions, accepted by the Society for Biomolecular Sciences (SBS), for devices used in high throughput applications related to the use of microtiter plates (e.g., multi-channel dispensers (manual or automated), pipette tip racks, pipette tips, and the like), in certain embodiments, as described in greater detail hereafter. Therefore, microtiter plates described herein often are configured for use with a wide variety of fluid dispensing devices in laboratory and clinical settings (e.g., multi-channel pipettors [e.g., 2, 4, 8, 12, channel manual or automated pipettors], robotic multi-channel dispensing heads [e.g., 8, 12, 24, 48, 96, 384, 1536, 6144, or 9600 channel dispensing heads] and the like).

The Society of Biomolecular Sciences (SBS)—Microplate Standards Development Committee, has developed and submitted microtiter plate standards for approval to the American National Standards Institute (ANSI), which in turn constrains the dimensions of devices and accessories used with microtiter plates. The ANSI standards for microplates were last updated Jan. 9, 2004, and can be found at World Wide Web (WWW), Uniform Resource Locator (URL), sbsonline.com/msdc/approved.php. The standards were created to help standardize equipment and accessories commonly used in high throughput automated clinical and/or laboratory settings. The microplate standardized footprint length is about 5.03 inches +/−0.02 inches and the standardized footprint width is about 3.37 inches +/−0.02 inches. The ANSI/SBS standards also set dimensions for other aspects of microtiter plates including but not limited to, well size, well spacing, distance between well centers, plate height, flange width, flange corner radii and the like.

Microtiter plate general features and dimensions

Microtiter plate 10, 10′ comprises plate 12, 12′ (also referred to interchangeably as plate top or plate upper surface), sidewalls 14, 14′, and a plurality of wells 18, 18′, as illustrated in 1-22. Microtiter pate 10, 10′ further comprises four (4) sidewalls 14, 14′, in some embodiments.

Sidewalls 14, 14′ often extend from or are coextensive with the perimeter of plate 12, 12′ and include sidewall flange 16, 16′, as illustrated in 1-22. Wells 18, 18′ include well aperture 20, 20′, well walls 22, 22′ and well bottom 24, 24′. In some embodiments, microtiter plate 10, 10′ is made from a polymer, and in certain embodiments the post manufacture thickness of the polymer of microtiter plate 10, 10′ or various components of microtiter plate 10, 10′ are in the range of about 0.00085 to 0.023 inches thick.

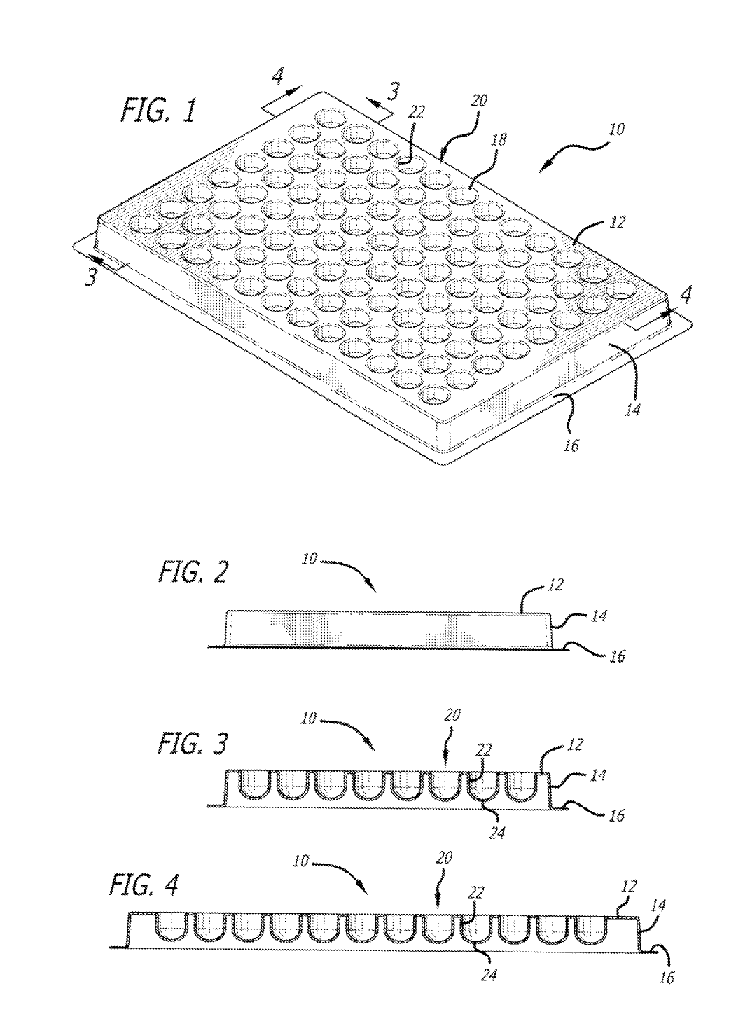

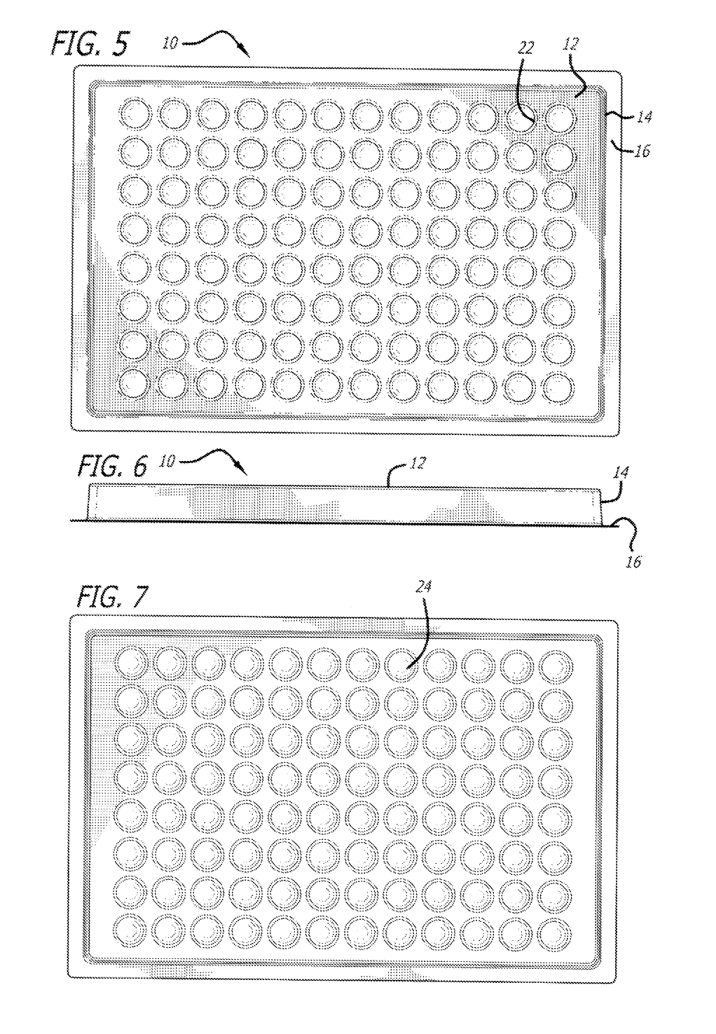

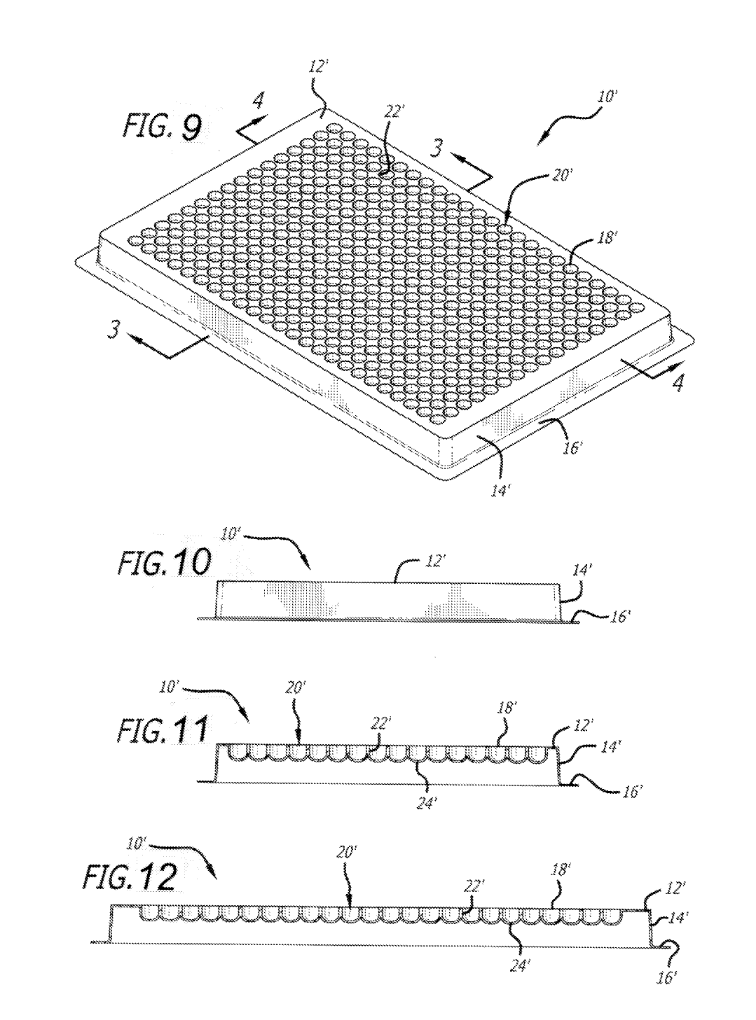

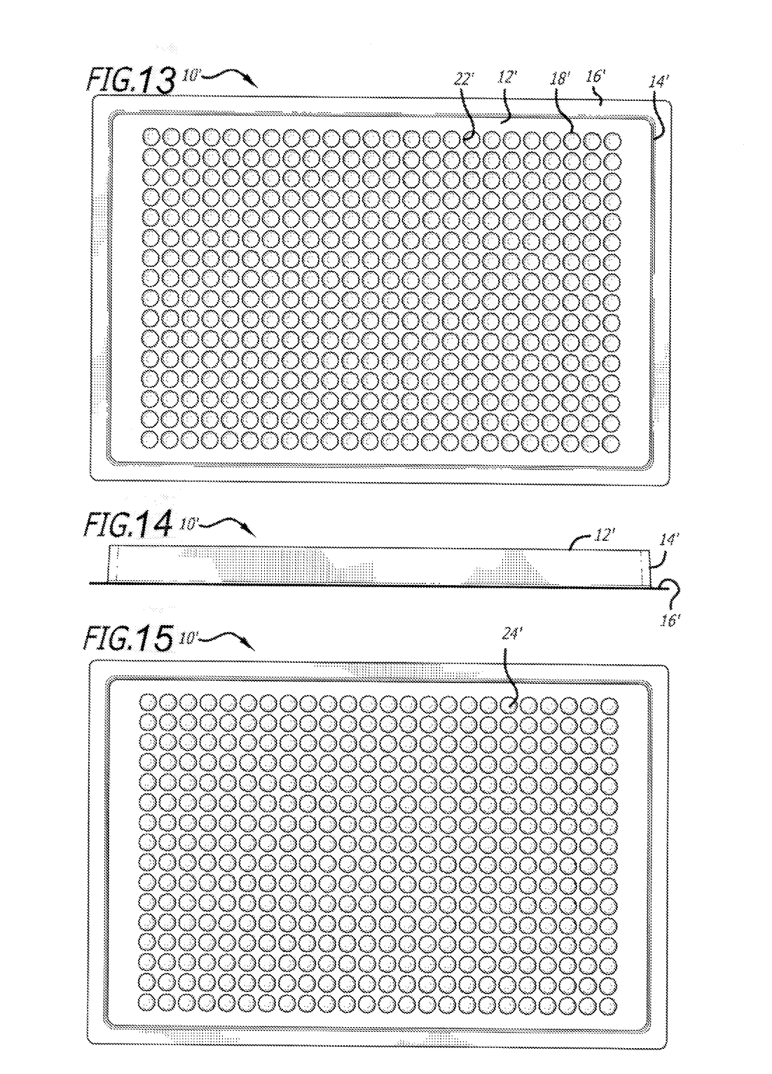

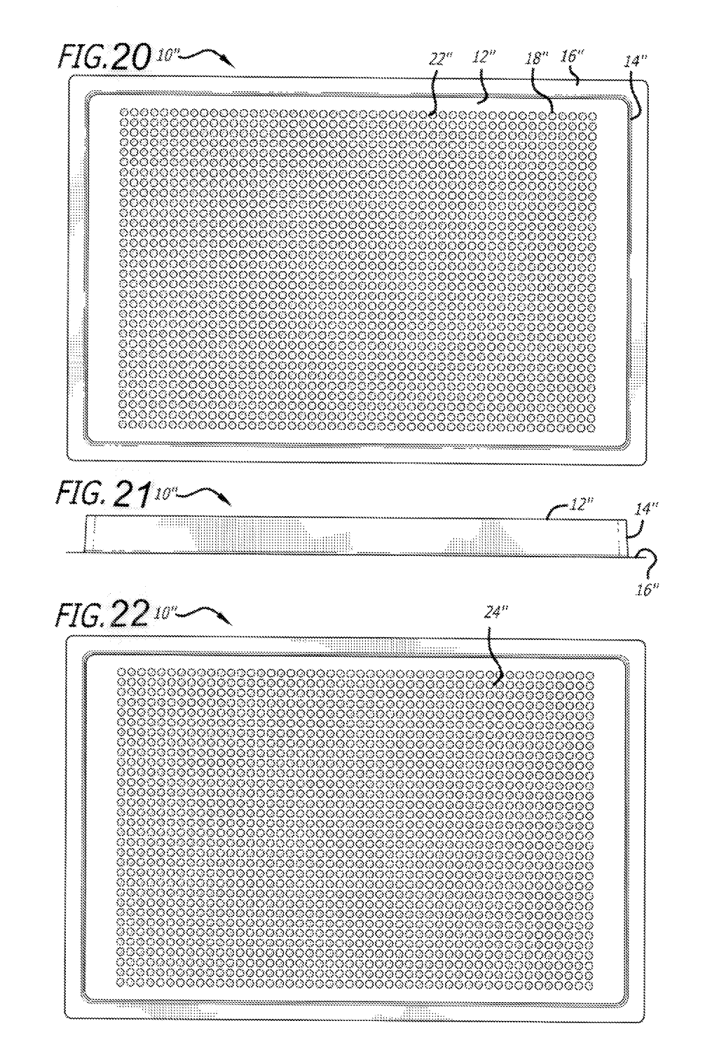

Plate 12, 12′ of microtiter plate 10, 10′ often is a substantially planar member, generally rectangular in shape, and with a plurality of wells 18, 18′ arranged in an array. Well arrays can be configured in any suitable pattern or shape and with any suitable number of wells with the proviso the resultant array is compatible with manual, automated or robotic dispensing devices available to the user. Non-limiting examples of microwell plates include 6 well, 8 well, 12 well, 24 well, 32 well, 64 well, 96 well, 384 well, 1536 well, 6144 well and 9600 well plates. The array in the embodiment illustrated in FIGS. 1-8 is a 12×8 array totaling 96 wells. Microtiter plate 10, 10′ embodiments described herein sometimes can be configured with a well array of 24×16 (e.g., 384 wells) or a well array of 24×32 array (e.g., 1536 wells), as illustrated in FIGS. 9-15 and FIGS. 16-22, respectively. Plate 12, 12′ upper surface sometimes is bossed or detent with reference characters allowing row and column positional identification of wells.

In some embodiments the planar surface of plate 12, 12′ has a length in the range of about 4.65 inches to about 4.9 inches, measured from sidewall 14, 14′ base to sidewall 14, 14′ base along the longest dimension of microtiter plate 10, 10′. In certain embodiments the planar surface of plate 12, 12′ has a width in the range of about 3.00 inches to about 3.25 inches, measured from sidewall 14, 14′ base to sidewall 14, 14′ base across the width of microtiter plate 10, 10′ (e.g., the non-length dimension). In some embodiments, the sidewalls comprise a substantially vertical surface.

Therefore, measurement of the planar surface of plate 12, 12′ at sidewall base or upper surface edges often yields substantially identical dimensions.

Microtiter plate 10, 10′ described herein, has a footprint length in the range of about 4.95 inches to about 5.10 inches (e.g., length of about 4.95 inches, about 4.96 inches, about 4.97 inches, about 4.98 inches, about 4.99 inches, about 5.00 inches, about 5.01 inches, about 5.02 inches, about 5.03 inches, about 5.04 inches, about 5.05 inches, about 5.06 inches, about 5.07 inches, about 5.08 inches, about 5.09 inches and about 5.10 inches), measured from sidewall flange 16, 16′ edge to sidewall flange 16, 16′ edge across the longest dimension, in some embodiments, as illustrated in the figures. In certain embodiments, microtiter plate 10, 10′ described herein has a footprint width in the range of about 3.33 inches to about 3.44 inches (e.g., length of about 3.33 inches, about 3.34 inches, about 3.35 inches, about 3.36 inches, about 3.37 inches, about 3.38 inches, about 3.39 inches, about 3.40 inches, about 3.41 inches, about 3.42 inches, about 3.43 inches and about 3.44 inches), measured from sidewall flange 16, 16′ edge to sidewall flange 16, 16′ edge across the width of the microplate (e.g., the non-length dimension), as illustrated in the figures.

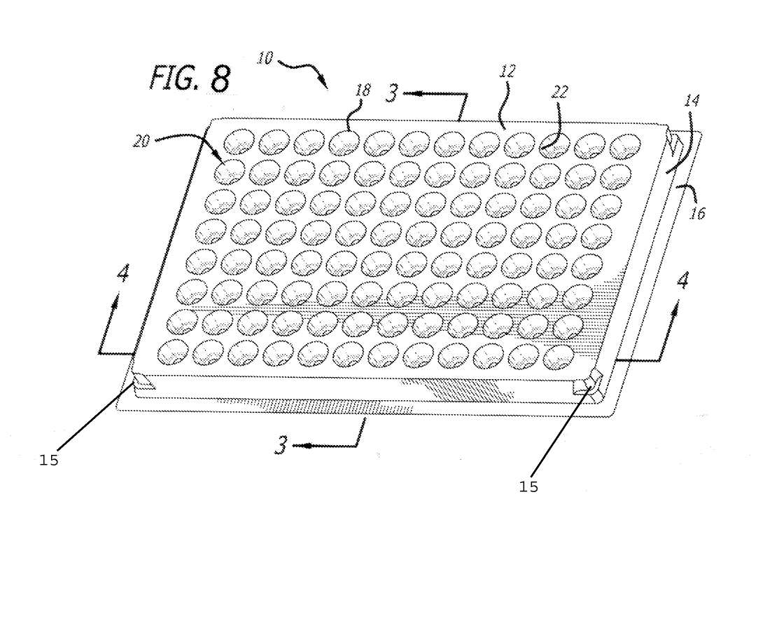

Microtiter plate 10, 10′ described herein comprises a sidewall 14, 14′ height less than the sidewall height set by the ANSI standards for microtiter plates, in some embodiments. The microtiter plates described herein are sometimes referred to as “low profile” microtiter plates. The term “low profile” as used herein with reference to microtiter plate height or microtiter plate sidewall height, refers to a lower sidewall height of the plates described herein as compared to the sidewall height of standard microtiter plates. The low profile height facilitates manufacture of wells having thinner side walls with little or no wall non-uniformity. Microtiter plates described herein often have a sidewall 14, 14′ height in the range of about 0.30 to about 0.50 inches (e.g., about 0.30, about 0.35, about 0.40, about 0.45, or about 0.50 inches), measured from sidewall flange 16, 16′ edge to sidewall 14, 14′ top edge. In some embodiments, the corners of the microtiter plates near the junction between sidewalls and upper surface, optionally comprise a detent or cutout surface, as illustrated in FIG. 8. In some embodiments, optional detent or cutout corner surface 15 is used to help immobilize the microtiter plate, and in certain embodiments, optional detent or cutout corner surface 15 ensures the plates do not lock or nest when plates are stacked. Detent or cutout corner surface 15 can optionally be included in any microtiter plate embodiment described herein.

In some embodiments, sidewall flange 16, 16′ is angled with respect to the base or bottom edge of sidewall 14, 14′. Sidewall flange 16, 16′ often is angled in the range of about 85 to about 95 degrees with respect to the base of sidewall 14, 14′. That is, sidewall flange 16 can be angled about 85 degrees, 86 degrees, 87 degrees, 88 degrees, 89 degrees, 90 degrees, 91 degrees, 92 degrees, 93 degrees, 94 degrees, or about 95 degrees, with respect to the base of sidewall 14, 14′. In certain embodiments, sidewall flange 16, 16′ is angled in the range of about 91 and about 95 degrees with respect to the base of sidewall 14, 14′.

As noted above, plate 12, 12′ of microtiter plate 10 has a plurality of wells 18, 18′ each of which comprises a well aperture 20, 20′. Well aperture 20, 20′ often is coextensive and/or coplanar with the surface of plate 12, 12′, in certain embodiments. In some embodiments, well walls 22, 22′ extend from or are coextensive with plate 12, 12′, and in certain embodiments well walls 22, 22′ extend from or are coextensive with well bottom 24, 24′, as illustrated in FIGS. 1-22. Wells 18, 18′ can have any useful or convenient cross-sectional shape useable with pipette tips or liquid dispensing channels. In certain embodiments, the well shape can be chosen to allow fitting the maximum number of wells into a given area. Well walls sometimes are touching to allow, and/or because of, fitting the maximum number of wells into a given area. In some embodiments, the cross-sectional shape is chosen from a circle, a square, a triangle or a polygon. Microtiter plate 10, 10′ embodiments illustrated in FIGS. 1-22 often are configured with wells having a circular cross-sectional shape. Well aperture 20, 20′ sometimes has the same cross-sectional shape as well 18, 18′, and sometimes has a different cross-sectional shape than well 18, 18′.

Well wall 22, 22′ often is coextensive with well aperture 20, 20′ and well bottom 24, 24′. Well wall 22, 22′ can be angled with respect to the planar surface of plate 12, 12′, in some embodiments. In certain embodiments, well wall 22, 22′ can be substantially vertical with respect to the planar surface of plate 12, 12′. In some embodiments, well wall 22, 22′ may comprise substantially vertical surfaces that are coextensive with angled surfaces (a stepped well bottom, for example). In certain embodiments, well wall 22, 22′ may comprise angled surfaces that are coextensive with other independently angled and/or curved surfaces (e.g., a stepped well bottom or a round well bottom, respectively).

Well wall 22, 22′ sometimes is angled or sloped in the range of about 1 degree to about 20 degrees with respect to a reference surface (e.g., a reference surface can be a horizontal surface, a vertical surface or an angled surface). That is, well wall 22, 22′ sometimes can be angled about 1 degree, about 2 degrees, about 3, degrees, about 4 degrees, about 5 degrees, about 6 degrees, about 7 degrees, about 8 degrees, about 9 degrees, about 10 degrees, about 11 degrees, about 12 degrees, about 13 degrees, about 14 degrees, about 15 degrees, about 16 degrees, about 17 degrees, about 18 degrees, about 19 degrees or about 20 degrees with respect to a reference surface. In some embodiments the angle or slope of well wall 22, 22′ minimizes or eliminates liquid adhering to the inner surface of well wall 22, 22′, by providing a slope for liquid to flow towards well bottom 24, 24′. The combination of well wall 22, 22′, sloped surface, gravity, and surface tension and/or surface adhesion properties of the polymer material, facilitates the complete and efficient flow of many liquids towards well bottom 24, 24′.

Well bottom 24, 24′ can have any useful or convenient shape. In some embodiments, well bottom 24, 24′ can be coplanar with the bottom edge of sidewall 14, 14′ or sidewall flange 16, 16′. That is, the outer surface of well bottom 24, 24′ sometimes is coplanar with sidewall flange 16, 16′ or the base surface of sidewall 14, 14′. The well bottom shape sometimes is chosen to offer additional support in embodiments where well bottom 24, 24′ is coplanar with sidewall 14, 14′ or sidewall flange 16, 16′. In certain embodiments, the shape of well bottom 24, 24′ is chosen to ensure maximum fluid recovery, (e.g., minimize dead volume).

In some embodiments, well bottom 24, 24′ is flat. In certain embodiments, well bottom 24, 24′ is round, as illustrated in FIGS. 3, 4, 11, 12, 18 and 19. In some embodiments, well bottom 24, 24′ is stepped. In certain embodiments, well bottom 24, 24′ is an inverted cone shape, and in some embodiments well bottom 24, 24′ is a V-shape.

Microtiter plate well configurations

As noted above, microtiter plates embodiments 10, 10′ described herein can be configured in a variety of well array formats. Illustrated in FIGS. 1-22 are microtiter plates configured with 96 wells, 384 wells, or 1536 wells. Described below are features specific to each well configuration, including well depth to well diameter ratio.

The term “well depth to well width ratio” as used herein refers to the depth of the well divided by the width of the well, and can be expressed by the formula W_{dd}=W_{d}/W_{w}, where W_{dd} refers to the well depth to width ratio, W_{d} refers to well depth and W_{w} refers to well width. This ratio, also referred to as a “well depth to well diameter ratio” can be used to estimate the amount of wall thickness variation that might occur during the forming process of the microtiter plate. The well depth to diameter ratio is similar to the draw ratio sometimes used in vacuum forming or thermoforming manufacturing processes. High well depth to well diameter ratios (e.g., greater than 2) sometimes can result in wall irregularities in certain types of manufacturing processes.

96 well microtiter plate

In some embodiments, microtiter plate embodiments 10 described herein are configured with 96 wells arranged in a 12×8 array, as illustrated in FIGS. 1-8. Wells 18, when arranged in a 96 well configuration have an aperture diameter in the range of about 0.265 inches to about 0.320 inches. Wells 18, when arranged in a 96 well configuration have a well depth in the range of about of 0.240 inches to about 0.300 inches. In certain embodiments, wells 18 have a volumetric capacity in the range of about 175 microliters and 225 microliters. The volumetric capacity of standard depth wells in a 96 well plates is in the range of about 250 to about 500 microliters. Wells 18 of microtiter plate 10 often have a well center to well center distance in the range of about 0.340 inches to about 0.360 inches. Microtiter plate embodiments 10, 10′ configured with 96 wells often have a well depth to diameter ratio (W_{dd}) in the range of about 0.50 to about 1.75 (e.g., ratio of about 0.55, 0.60, 0.65, 0.70, 0.75, 0.80, 0.85, 0.90, 0.95, 1.00, 1.05 or 1.10, 1.15, 1.20, 1.25, 1.30, 1.35, 1.40, 1.45, 1.50, 1.55, 1.60, 1.65, or 1.70).

384 well microtiter plate

In some embodiments, microtiter plate embodiments 10′ described herein are configured with 384 wells arranged in a 24×16 array, as illustrated in FIGS. 9-15. Wells 18′, when arranged in a 384 well configuration have an aperture diameter in the range of about 0.130 inches to about 0.165 inches, with an average aperture diameter of about 0.148 inches. Wells 18′, when arranged in a 384 well configuration have a well depth in the range of about of about 0.115 inches to about 0.145 inches, with an average well depth of about 0.130 inches. In certain embodiments, wells 18′ have a volumetric capacity in the range of about 10 microliters and 90 microliters. The volumetric capacity of standard depth wells in a 384 well plates is in the range of about 10 microliters (e.g., minimum working volume) and about 120 microliters. Wells 18′ of microtiter plate 10′ often have a well center to well center distance in the range of about 0.172 inches to about 0.182 inches. Microtiter plate embodiments 10′ configured with 384 wells often have a well depth to diameter ratio (W_{dd}) in the range of about 0.70 to about 1.15 (e.g., ratio of about 0.75, 0.80, 0.85, 0.90, 0.95, 1.00, 1.05 or 1.10).

1536 well microtiter plate

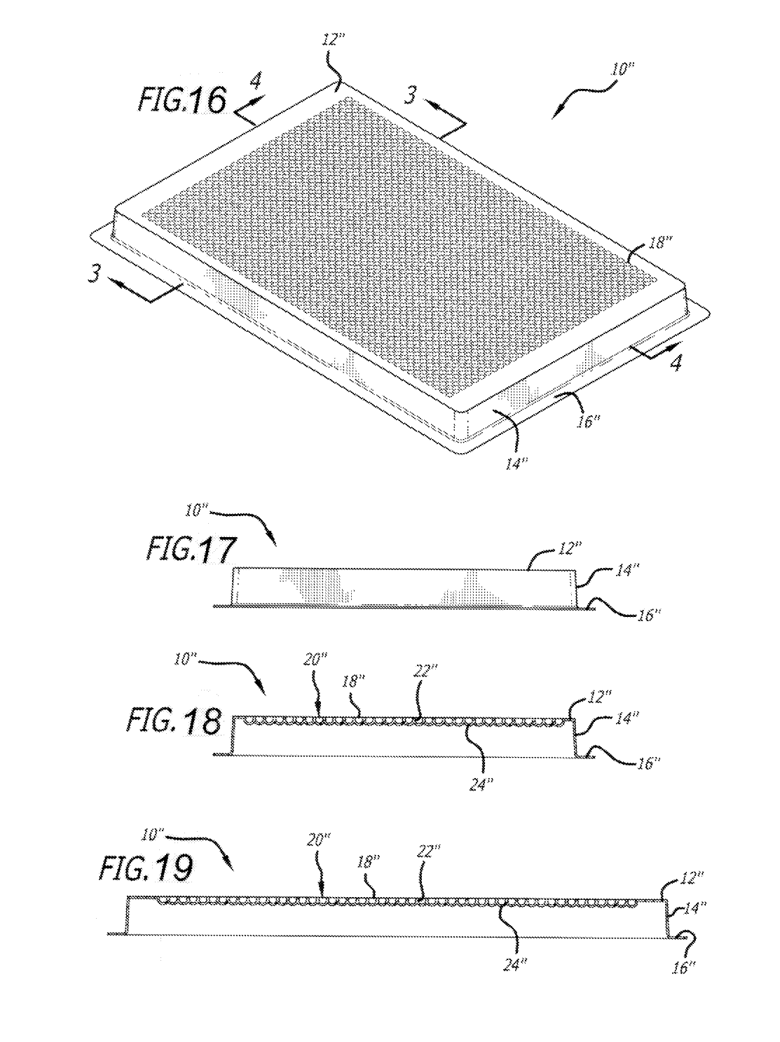

In some embodiments, microtiter plate embodiments 10′ described herein are configured with 1536 wells arranged in a 48×32 array, as illustrated in FIGS. 16-23. Wells 18′, when arranged in a 1536 well configuration have an aperture diameter in the range of about 0.060 inches to about 0.075 inches, with an average well diameter of about 0.068 inches. Wells 18′, when arranged in a 1536 well configuration have a well depth in the range of about of 0.035 inches to about 0.065 inches.

In certain embodiments, wells 18′ have a volumetric capacity in the range of about 1 microliter and 8 microliters. The volumetric capacity of standard depth wells in a 1536 well plates is in the range of about 1 microliter (e.g., minimum working volume) to about 12 microliters. Wells 18′ of microtiter plate 10′ often have a well center to well center distance in the range of about 0.085 inches to about 0.095 inches. Microtiter plate embodiments 10′ configured with 1536 wells often have a well depth to diameter ratio (W_{dd}) in the range of about 0.70 and about 1.15 (e.g., ratio of about 0.75, 0.80, 0.85, 0.90, 0.95, 1.00, 1.05 or 1.10).

6144 well microtiter plate

In some embodiments, microtiter plate embodiments 10′ described herein are configured with 6144 wells arranged in a 96×64 array. Wells 18′, when arranged in a 6144 well configuration have an aperture diameter in the range of about 0.030 inches to about 0.040 inches, with an average well diameter of about 0.035 inches. In some embodiments having 6144 wells, wells have a volume in the range of about 1 microliters to about 4 microliters. In certain embodiments, the wells further comprise a well center to well center distance in the range of about 0.040 inches to about 0.050 inches. In some embodiments, the wells have a well depth to well diameter ratio in the range of about 0.70 to about 1.15 (e.g., ratio of about 0.75, 0.80, 0.85, 0.90, 0.95, 1.00, 1.05 or 1.10).

Microtiter plate materials

Microtiter plates described herein can be manufactured from a variety of polymers or plastics. In some embodiments, the polymers are biodegradable and in certain embodiments the polymers are not biodegradable. In some embodiments, the polymer (degradable or non-degradable, for example) can contain an additive and/or be treated to enhance the ability of the microtiter plate to be used with automated microtiter plate readers (e.g., devices that can measure light absorbance, light transmittance, luminescence, fluorescence, combinations thereof and the like, through the walls of microtiter plates). Non-limiting examples of polymer additives useful for enhancing the ability of microtiter plates to be used in optical detection methods, include titanium dioxide (gives the polymer a white color and enhances optical absorbance or luminescence detection, for example) or carbon (e.g., useful to enhance fluorescence detection).

Non-limiting examples of non-degradable polymers suitable for use in embodiments described herein include polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystryrene, acrylnitrile butadiene styrene copolymers, crosslinked polysiloxanes, polyurethanes, (meth)acrylate-based polymers, cellulose and cellulose derivatives, polycarbonates, ABS, tetrafluoroethylene polymers, plastics with higher flow and lower viscosity, a combination of two or more of the foregoing, corresponding copolymers and the like. In some embodiments the polymer can be contain an additive and/or be treated to enhance the ability of the microtiter plate to be used with automated microtiter plate readers (e.g., device that can measure light absorbance, light transmittance, fluorescence, combinations thereof and the like). Non-limiting examples of polymer additives include titanium dioxide (gives the polymer a white color and enhances optical absorbance or luminescence detection, for example), binding agents or carbon (e.g., carbon black, for fluorescence detection).

Degradable plastics can be categorized into three groups: biodegradable plastics, photo-degradable plastics and plastics that are biodegradable and photodegradable. Also there are different categories of degradation. Environmental degradation of plastics generally is caused by exposure to the environmental effects of sunlight, microorganisms, insects, animals, heat, water, oxygen, wind, rain, traffic, and the like, sometimes in combination. Biodegradation is caused by the action of living organisms, such as fungi and bacteria for example. Oxidative degradation is caused by the action of oxygen and ozone. Photo-degradation results from exposure to sunlight, particularly the ultraviolet rays thereof, and to other sources of light (e.g., intense sources of light).

The term “degradable” as used herein refers to a substance that can be broken down into smaller units (e.g., into water, carbon dioxide, ammonia sulfur dioxide) by certain environmental components (e.g., water, light, microbes). The term “biodegradable” as used herein refers to a substance that can be broken down into smaller units by living organisms. Biodegradation may refer to a natural process of a material being degraded under anaerobic and/or aerobic conditions in the presence of microbes (e.g., fungi) and one or more of nutrients, carbon dioxide/methane, water, biomass and the like. Degradation may break down the multilayer structure of an object.

An object subject to biodegradation may become part of a compost that is subjected to physical, chemical, thermal, and/or biological degradation in a solid waste composting or biogasification facility, in some embodiments. The term “biomass” as used herein refers to a portion of metabolized materials that is incorporated into the cellular structure of organisms present or converted to humus fractions indistinguishable from material of biological origin.

The degree of degradation can be measured by different methods. In certain embodiments, degradation occurs when about 60 to about 90 percent of a product decomposes within about 60 to about 180 days of being placed in a composting environment. In certain embodiments, the mass (e.g., weight, grams, pounds) of a product remaining, or the mass that has decomposed, after decomposition is determined. In some embodiments, the volume (e.g., cubic inches, centimeters, yards, meters; gallons, liters) of a product remaining, or the volume that has decomposed, after decomposition is determined. The mass or volume of the object(s) being degraded may be measured by any known method. In some embodiments degradation occurs when about 50 to 60, 50 to 70, 50 to 80, 60 to 70, 60 to 80, 70 to 80, or 70 to 90 percent of a product decomposes, as measured by mass or volume. In some embodiments degradation is determined after about 50 to 100, 60 to 100, 70 to 100, 80 to 100, 90 to 100, 100 to 200, 110 to 200, 120 to 200, 130 to 200, 140 to 200, 150 to 200, or 160 to 100 days have elapsed from the time an object was placed in a composting environment. For example, the litter bag method, direct observation method, harvesting litter plots, comparing paired plots, input-output structural decomposition analysis (SDA), or methods used by the American National Standards Institute and/or the American Society for Testing and Materials may be utilized in certain embodiments.

Conditions that provide more rapid or accelerated degradation, as compared to storage or use conditions, are referred to herein as “composting conditions.” Composting generally is conducted under conditions sufficient for degradation to occur (e.g. disintegration to small pieces, temperature control, inoculation with suitable microorganisms, aeration as needed, and moisture control). A composting environment sometimes is a specific environment that induces rapid or accelerated degradation, and degradation and composting often are subject to some degree of control. For example, the environment in which materials undergo physical, chemical, thermal and/or biological degradation to carbon dioxide/methane, water, and biomass can be subject to some degree of control and/or selection (e.g., a municipal solid waste composting facility). The efficiency of a composting process for biodegradation, for example, often is dependent upon the action of aerobic bacteria. Composting bacteria are most active within a somewhat limited range of oxygen, temperature and moisture contents. Therefore, the efficiency of the composting process can be enhanced by operator control of the oxygen content, temperature, and moisture content of a compost pile.

The nature of binder polymers used in plastics often determines whether a plastic is biodegradable. A reason traditional plastics may not be degradable is because their long polymer molecules are too large and too tightly bonded together to be broken apart and assimilated by decomposer organisms and/or conditions. In composting environments olefins, poly vinyl chloride, epoxides and phenolics often do not biodegrade readily. An approach to environmental degradability of articles made with synthetic polymers is to manufacture a polymer that is itself biodegradable or compostable. Plastics based on natural plant polymers derived from wheat or corn starch have molecules that are readily attacked and broken down by microbes. A synthetic material can be considered biodegradable if the extent (and optionally the rate) of biodegradation is comparable to that of naturally occurring materials (e.g., leaves, grass clippings, sawdust) or to synthetic polymers that are generally recognized as biodegradable in the same environment. The parameters of the composting environment sometimes are not constant throughout the composting process. For example, bacteriological activity in a new composting pile which contains a great deal of free organic matter is much higher than the activity in an older, more nearly fully composted pile.

Biodegradable plastics that have been developed are classified into the following four categories, which partially overlap each other: (a) naturally-occurring polymers consisting of polysaccharides (e.g., starch and the like); (b) microbial polyesters that can be degraded by the biological activities of microorganisms (e.g., polyhydroxyalkanoates and the like); (c) conventional plastics mixed with degradation accelerators (e.g., mixtures having accelerated degradation characteristics such as photosensitizers); and (d) chemosynthetic compounds (e.g., aliphatic polyesters and the like).

Plastics Produced by Natural Resources

Natural polymer degradable materials often are based on natural polymeric materials (e.g., starch and cellulose) that are chemically modified to improve physical properties (e.g., strength and the ability to repel water). Examples of degradable natural polymers include, without limitation, starch/synthetic biodegradable plastic, cellulose acetate, chitosan/cellulose/starch and denatured starch. Non-starch biodegradable components may include chitin, casein, sodium (or zinc, calcium, magnesium, potassium) phosphate and metal salt of hydrogen phosphate or dihydrogen phosphate, amide derivatives of erucamide and oleamide and the like, for example. Synthetic blends allow bacteria to colonize on the natural polymers and degrade the plastic polymers once established.

Attempts have been made to produce degradable plastics by incorporating starches into polymers. This approach, however, has contributed a unique set of problems. Starch is hydrophilic, while polyethylene is hydrophobic, and the two are not compatible with one another. Also, when more starch is introduced into a polymer, the resulting plastic film may have poor tensile strength. To incorporate starches into polymers, a general-purpose plasticizer (for example, phthalate type or fatty ester type) humectants, and/or porous aggregate may be added to the mixture to increase the flexibility (for example, injection workability, extrusion workability, stretchability, and the like) at the same levels as ordinary thermoplastic plastics (i.e. thermoplastic resin). Also, a biodegradable resin (biodegradable polymer) other than a starch ester may be added to improve the impact strength or tensile elongation of the starch ester. Polycaprolactone, polylactic acid or cellulose acetate are non-limiting examples of biodegradable resins that may be incorporated. To decrease the cost and to impart desirable properties to the final article, organic and/or inorganic fillers or aggregates can be added to the mixture in an amount greater than about 20% and up to as high as about 90% by weight of the total solids in the mixture. Non-limiting examples of organic fillers include starch, cellulose fiber, cellulose powder, wood powder, wood fiber, pulp, pecan fiber, cotton linters, lignin, grain husks, cotton powder, and the like. Examples of inorganic fillers include, without limitation, talc, titanium oxide, clay, chalk, limestone, calcium carbonate, mica, glass, silica and various silica salts, diatomaceous earth, wall austenite, various magnesium salts, various manganese salts and the like. Rheology-modifying agents, such as cellulose-based, polysaccharide-based, protein-based, and synthetic organic materials, for example, can be added to control the viscosity and yield stress of the mixture. U.S. Pat. No. 7,332,214 to Ozasa et al., U.S. Pat. No. 6,833,097 to Miyachi, and U.S. Pat. No. 6,617,449 to Tanaka all incorporated herein in their entirety by reference and for all purposes, are examples of devices composed of biodegradable plastics produced from natural polymers.

Degradable natural plastic compositions used to manufacture microtiter plates often have one or more of the following properties: provide a stable structure and adjust to a biodegradable rate of decomposition, improve hydrolysis resistance and heat resistance, retain transparency, and are moldable. One or more of a plasticizer, resin, filler, and/or rheology modifying agent may be used in the degradable polymer composition to improve function and cost effectiveness. In certain embodiments a device can include a natural plastic, or a combination of natural plastics, in an amount of about 15 to about 95 percent by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Plastics Produced by Microbes

Degradable polymeric materials that can be used to manufacture a device often can decompose to low molecular weight substances (e.g., via microbes). Degradable microbe-produced polymeric materials often are produced by selecting microbes that can produce polyesters as energy storing substances, and the microbes can be are activated for fermentation under optimized conditions. Non-limiting examples of degradable microbe-produced polymeric materials include homopolymers, polymer blends, aliphatic polyesters, chemosynthetic compounds and the like.

Bacterial cellulose can be used for forming degradable polymers, and may contain cellulose and hetero-oligosaccharides. Without being limited by theory, in such polymers cellulose generally operates as the principal chain or glucans such as beta-1, 3 and beta-1, 2 glucans. Bacterial cellulose containing hetero-oligosaccharides also may contain components such as hexa-saccharides, penta-saccharides and organic acids such as mannose, fructose, galactose, xylose, arabinose, rhamnose and glucuronic acid, for example. Examples of microbes that can produce bacterial cellulose include, but are not limited to, Acetobacter aceti subspecies xylinum, Acetobacter pasteurianus, Acetobacter rancens, Sarcina ventriculi, Bacterium xyloides, pseudomonades and Agrobacteria.

Bacterial cellulose may contain a single polysaccharide or two or more polysaccharides existing in a mixed state under the effect of hydrogen bonds. A polymeric composite material may contain bacterial cellulose including ribbon-shaped micro-fibrils and a biodegradable polymeric material, for example. Bacterial cellulose and biodegradable polymeric material can be biologically decomposed by respective microbes living in soil and/or in water in certain embodiments, and the bacterial cellulose can improve various physical properties of the polymeric composite material including its tensile strength for example.

Polyesters can be used in degradable materials, and they often are utilized in a cost effective manner. Degradable polyesters can be described as belonging to three general classes: aliphatic polyesters, aliphatic-aromatic polyesters and sulfonated aliphatic-aromatic polyesters. Synthetic aliphatic polyesters often are synthesized from diols and dicarboxylic acids via condensation polymerization, and can completely biodegrade in soil and water. Aliphatic polyesters have better moisture resistance than starches, which have many hydroxyl groups. Aliphatic-aromatic polyesters also may be synthesized from diols and dicarboxylic acids. Sulfonated aliphatic-aromatic polyesters can be derived from a mixture of aliphatic dicarboxylic acids and aromatic dicarboxylic acids and, in addition, can incorporate a sulfonated monomer (e.g., salts of 5-sulfoisophthalic acid). In an embodiment of the present technology, these polyesters are blended with starch-based polymers for cost-competitive degradable plastic applications.

In some embodiments, degradable aliphatic polyesters include without limitation polycaprolactones, polylactic acids (PLA), polyhydroxyalkanoates (PHA), polyhydroxyhexanoate (PHH), polybutylene succinate (PBS), polycaprolactone (PCL), polyhydroxyvalerate (PHV), polyhydroxybutyrate (PHB), polybutylene succinate adipate (PBSA), PHB/PHV, PHB/PHH, and aliphatic polyesters that are polycondensed from diol and diacid, or mixtures thereof. Other degradable aliphatic-aromatic polyesters include, without limitation, modified polyethylene terephthalate (PET), aliphatic-aromatic copolyesters (AAC), polybutylene adipate/terephthalate (PBAT), and polymethylene adipate/terephthalate (PTMAT).

Degradable polymeric plastics sometimes have a high hydrolytic property such that they tend to degrade by exposure to moisture in the atmosphere and hence have poor stability over time. To offset such drawbacks, compounds such as carbodiimides may be used to stabilize the structure and provide a longer lifespan for the plastics, for example. A side effect of using this compound, however, may be an undesired odor. Polycarbodiimide is another compound that may be used to stabilize against hydrolysis and sometimes results in a yellow hue as a side effect. U.S. Pat. No. 7,129,190 to Takahashi et al., U.S. Pat. No. 7,368,493 to Takahashi et al., U.S. Pat. No. 6,846,860 to Takahashi et al, U.S. Pat. No. 5,973,024 to Imashiro et al., U.S. Pat. No. 6,107,378 to Imashiro et al. all incorporated herein in their entirety by reference and for all purposes, are examples of devices that have been prepared using carbodiimides and/or polycarbodiimides.

A common commercial PHA consists of a copolymer PHB/PHV together with a plasticiser/softener (e.g. triacetine or estaflex) and inorganic additives such as titanium dioxide and calcium carbonate, for example. PHB homopolymer often is a stiff and rather brittle polymer of high crystallinity, having mechanical properties similar to polystyrene, though the former is less brittle. PHB copolymers may be used for general purposes as the degradation rate of PHB homopolymer is relatively high at its normal melt processing temperature. PHB and its copolymers with PHV are melt-processable semi-crystalline thermoplastics made by biological fermentation from renewable carbohydrate feedstocks. No toxic by-products are known to result from PHB or PHV.

Aliphatic-aromatic (AAC) copolyesters combine degradable properties of aliphatic polyesters with the strength and performance properties of aromatic polyesters. This class of degradable plastics shares similar property profiles to those of commodity polymers such as polyethylene. AACs may be blended with starch to reduce cost, for example. AACs often are closer than other biodegradable plastics to equaling the properties of low density polyethylene, especially for blown film extrusion. AACs also have other functional properties, such as transparency which is good for cling film, and flexibility and anti-fogging performance, for example.

Modified PET (polyethylene tetraphalate) is a PET that contains co-monomers, such as ether, amide and/or aliphatic monomers, the latter of which can provide ‘weak’ linkages susceptible to degradation through hydrolysis and microbial processing, for example. Modified PET can be degraded by a combination of hydrolysis of ester linkages and enzymatic attack on ether and amide bonds, for example. With modified PET it is possible to adjust and control degradation rates by varying the co-monomers used. Depending on the application, one, two or three aliphatic monomers can be incorporated into the PET structure, in some embodiments. Modified PET materials include PBAT (polybutylene adipate/terephthalate) and PTMAT (polytetramethylene adipate/terephthalate), for example. Modified PET is hydro-biodegradable, with a biodegradation step following an initial hydrolysis stage, for example.

Degradable microbe-produced plastics used to manufacture microtiter plates often have one or more of the following properties: provide a stable structure, provide a degradable rate of decomposition, improve hydrolysis resistance and heat resistance, and retain transparency. In certain embodiments a device may include a degradable microbe-produced polymeric plastic, or combination of such plastics, in an amount of about 15 to about 95 percent by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Photodegradable Plastics and Decomposition Accelerators

Photodegradation is the decomposition of photosensitive materials initiated by a source of light. Without being bound by theory, photodegradation is degradation of a photodegradable molecule in the plastic of a device caused by the absorption of photons, particularly those wavelengths found in sunlight, such as infrared radiation, visible light and ultraviolet light. Other forms of electromagnetic radiation also can cause photodegradation. Photodegradation includes alteration of certain molecules (e.g., denaturing of proteins; addition of atoms or molecules). A common photodegradation reaction is oxidation. A photodegradable plastic contains photosensitive materials as well as biodegradable materials in certain embodiments.

Photodegradablity is an inherent property of some polymers and in certain cases it can be enhanced by the use of photosensitizing additives. Photodegradable plastics have found use in applications such as agricultural mulch film, trash bags, and retail shopping bags. U.S. Pat. No. 5,763,518 to Gnatowski et al. or U.S. Pat. No. 5,795,923 to Shahid or U.S. Pat. No. 4,476,255 to Bailey et al., all incorporated herein in their entirety by reference and for all purposes, include examples of devices composed of photodegradable plastics. A plastic composition may become photodegradable by uniformly dispersing photosensitizers throughout the body of the composition in some embodiments. In certain embodiments, photosensitizers can be organic and/or inorganic compounds and compositions that are photoreactive upon exposure to light in the ultraviolet spectrum.

Photosensitizers useful for devices herein include without limitation compounds and compositions known to promote photo-oxidation reactions, photo-polymerization reactions, photo-crosslinking reactions and the like. Photosensitizers may be aliphatic and/or aromatic ketones, including without limitation acetophenone, acetoin, 1′-acetonaphthone, 2′-acetonaphtone, anisoin, anthrone, bianthrone, benzil, benzoin, benzoin methyl ether, benzoin isopropyl ether, 1-decalone, 2-decalone, benzophenone, p-chlorobenzophenone, dibenzalacetone, benzoylacetone, benzylacetone, deoxybenzoin, 2,4-dimethylbenzophenone, 2,5-dimethylbenzophenone, 3,4-dimethylbenzophenone, 4-benzoylbiphenyl, butyrophenone, 9-fluorenone, 4,4-bis-(dimethylamino)-benzophenone, 4-dimethylaminobenzophenone, dibenzyl ketone, 4-methylbenzophenone, propiophenone, benzanthrone, 1-tetralone, 2-tetralone, valerophenone, 4-nitrobenzophenone, di-n-hexyl ketone, isophorone, xanthone and the like. Aromatic ketones may be used such as benzophenone, benzoin, anthrone and deoxyanisoin.

Also useful as photosensitizers are quinones, which include, without limitation, anthraquinone, 1-aminoanthraquinone, 2-aminoanthraquinone, 1-chloroanthraquinone, 2-chloroanthraquinone, 1-methylanthraquinone, 2-methylanthraquinone, 1-nitroanthraquinone, 2-phenylanthraquinone, 1,2-naphthoquinone, 1,4-naphthoquinone, 2-methyl-1,4-naphthoquinone, 1,2-benzanthraquinone, 2,3-benzanthraquinone, phenanthrenequinone, 1-methoxyanthraquinone, 1,5-dichloroanthraquinone, and 2,2′-dimethyl-1,1′-dianthraquinone, and anthraquinone dyes. Quinones that may be used are 2-methylanthraquinone, 2-chloroanthraquinone, 2-ethylanthraquinone and the like.

Peroxides and hydroperoxides also can be used. Non-limiting examples of such compounds include tert-butyl hydroperoxide, cumene hydroperoxide, diisopropylbenzene hydroperoxide, 2,5-dimethylhexane-2,5-dihydroperoxide, p-menthane hydroperoxide, 1,1,3,3-tetramethylbutyl hydroperoxide, acetyl peroxide, benzoyl peroxide, p-chlorobenzoyl peroxide, 2,4-dichlorobenzoyl peroxide, ditoluoyl peroxide, decanoyl peroxide, lauroyl peroxide, isobutyryl peroxide, diisononanoyl peroxide, perlargonyl peroxide, tert-butyl peroxyacetate, tert-butyl peroxymaleic acid, tert-butyl peroxyisobutyrate, tert-butyl peroxypivalate, tert-butyl peroxybenzoate, tert-butyl peroxycrotonate, tert-butyl peroxy-(2-ethylhexanoate), 2,5-dimethyl-2,5-bis-(2-ethylhexanoylperoxy) hexane, 2,5-dimethyl-2,5-bis-(benzoylperoxy) hexane, 2,5-dimethyl-2,5-bis-(tert-butylperoxy) hexane, 2,5-dimethyl-2,5-bis-(tert-butylperoxy)-hexyne-3, di-tert-butyl diperoxyphthalate, 1,1,3,3-tetramethylbutylperoxy2-ethyl-hexanoate, di-tert-butyl peroxide, di-tert-amyl peroxide, tert-amyl-tert-butyl peroxide, 1,1-di-tert-butylperoxy-3,3,5-trimethyl cyclohexane, bis-(tert-butylperoxy)-diisopropylbenzene, n-butyl-4,4-bis-(tert-butylperoxy)valerate, dicumyl peroxide, acetyl acetone peroxide, methyl ethyl ketone peroxide, cyclohexanone peroxide, tert-butylperoxy isopropyl carbonate, 2,2-bis-(tert-butylperoxy)butane, di-(2-ethylhexyl)peroxydicarbonate, bis-(4-tert-butylcyclohexyl)peroxydicarbonate and the like. Other compounds that may be used include, without limitation, benzoyl peroxide, dicumyl peroxide, dilauroyl peroxide, 2,5-dimethyl-2,5-di(t-butylperoxy) hexyne-3, and .alpha.,.alpha.′-bis (t-butylperoxy) diisopropylbenzene. Peroxides and hydroperoxides generally are thermally unstable and care must be exercised in combining a photosensitizer with a copolymer. Processing sometimes is conducted at a temperature below the decomposition temperature of the photosensitizer. Some compounds that can be used as a photosensitizer are azo compounds. Examples of azo compounds include, without limitation, 2-azo-bis-isobutyronitrile, 2-azo-bis-propionitrile, dimethyl-2-azo-bis-isobutyrate, 1-azo-bis-1-cyclohexanecarbonitrile, 2-azo-bis-2-methylheptanitrile, 2-azo-bis-2-methylbutyronitrile, 4-azo-bis-4-cyanopentanoic acid, azodicarbonamide, azobenzene, azo dyes and the like.

Biodegrading tests also have shown that the rate of photodecomposition of plastic materials and devices made from them can be accelerated by the addition of acetylacetonate or aklylbenzoyl acetate of iron, zinc, cerium cobalt, chromium, copper, vanadium and/or manganese compounds. These iron and/or manganese compounds are added in a quantity of up to about 15 percent by weight (e.g., up to about 14, 13, 12, 11, 10, 9, 8, 7, 6 and 5 percent by weight), as compared to the total weight of the remaining components, in some embodiments. Iron or manganese compounds used as decomposition accelerators may be inorganic or organic compounds in certain embodiments. Non-limiting examples of organic iron compounds that may be added are iron acetate or ferrocene or derivatives of bis-(cyclopentadienyl) iron or iron (II) acetylacetonate. Non-limiting examples of ferrocene derivatives include n-octyl ferrocene, n-octanoyl ferrocene, undecylenoyl ferrocene, .gamma.-ferrocenyl butyric acid, .gamma.-ferrocenyl butyl butyrate and the like, and thioaminocarboxylate compounds, such as iron diethyl dithiocarbamate, iron dibutyl dithiocarbamate and the like. Accelerants may be added by any known method, for example by coating, sprinkling, dipping and/or spraying in some embodiments.

Photodegradable materials used to manufacture devices herein often impart one or more of the following properties: provide a stable structure, provide a degradable rate of decomposition, improve hydrolysis resistance and heat resistance, and retain transparency. In certain embodiments a device can include a photodegradable plastic, or combination of such plastics, in an amount of about 15 to about 95 percent by total device weight (e.g., about 20 to about 40, about 45 to about 65, about 50 to about 60, about 50 to about 80, about 50 to about 70, about 45 to about 55, about 30 to about 50, about 30 to about 40, about 50 to about 70, about 60 to about 80, about 60 to about 90, about 75 to about 95, about 40 to about 50, about 25 to about 50, about 25 to about 35, about 20 to about 40, about 20 to about 30, and about 15 to about 25 percent degradable material by total device weight).

Additives and Polymer Attacking Agents

A degradable plastic may further contain, in addition to a plasticizer and filler, any other additives, such as one of more of the following non-limiting examples: colorants, stabilizers, antioxidants, deodorizers, flame retardants, lubricants, mold release agents, and the like. Any other materials that aid in degradation of a microtiter plate may be added, such as an auto-oxidizing agent. Non-limiting examples of auto-oxidizing agents include polyhydroxy-containing carboxylate, such as polyethylene glycol stearate, sorbitol palmitate, adduct of sorbitol anhydride laurate with ethylene oxide and the like; and epoxidized soybean oil, oleic acid, stearic acid, and epoxy acetyl castor oil and the like. Other additives may include coupling agents such as maleic anhydride, methacrylic anhydride or maleimide when starch and an aliphatic polyester are combined, for example.

One or more polymer attacking agents also may be used in conjunction with a degradable microtiter plate. Polymer attacking agents include, without limitation, enzymes and/or microorganisms (e.g., bacteria and fungi) that attack and cause the decay of a synthetic polymer and/or natural polymer component(s) of a degradable plastic. Anaerobic as well as aerobic bacteria may be used (e.g., Aspergillus oryzae, microorganisms recited in U.S. Pat. Nos. 3,860,490 and 3,767,790, and appropriate microorganisms listed in the American Type Culture Collection Catalogue of Fungi and Yeast 17th Ed. 1987, The Update of the Catalogue of Yeast and Fungi December 1988, The Catalogue of Bacteria and Phages 17th Ed. 1989, and the Catalohas of Microbes and Cells at Work 1st Ed. 1988). Enzymes (e.g., bacterial or fungal) that catalyze such decay (e.g., diastase, amylase and cellulase) also may be utilized.

Water often is present when a polymer attacking agent is utilized to degrade a plastic. Water can be applied in any convenient manner to the device(s). In some embodiments, water is applied to the interior of a compost environment, which can be accomplished by spraying water on the compost simultaneously with, or alternately with, turning over or churning the compost to expose dry or substantially dry areas to the water, for example. In some embodiments, a device can be degraded in conjunction with other processes, such as photodegradation, for example.

Hydro-Protective Coatings

A coating may be deposited on a degradable microtiter plate. The coating serves as a barrier coating in certain embodiments, which can perform one or more of the following functions, for example: reduce permeation of gases and/or liquids, protect plastic from chemical modification or degradation or ultraviolet radiation, provide a finished surface to the plastic, seal the plastic and/or impart extra strength to the plastic. The coating may be a film in some embodiments, and often is hydrophobic. A coating sometimes comprises a degradable plastic having similar qualities as common non-degradable plastics. A device herein (e.g., one that is mainly made of starch) can be rendered water resistant by applying a hydrophobic coating, for example.

The coating is of a chemical composition that forms a protective barrier over a portion, or all, of the surface area of a degradable device. A coating can include, without limitation, silicon, oxygen, carbon, hydrogen, an edible oil, a drying oil, melamine, a phenolic resin, a polyester resin, an epoxy resin, a terpene resin, a urea-formaldehyde rein, a styrene polymer, a polyvinyl chloride, polyvinyl alcohol, polyvinyl acetate, a polyacrylate, a polyamide, hydroxypropylmethylcellulose, methocel, polyethylene glycol, an acrylic, an acrylic copolymer, polyurethane, polylactic acid, a polyhydroxybutyrate-hydroxyvalerate copolymer, a starch, soybean protein, a wax, and a mixture thereof.

A coating may be applied by any known method, including, without limitation, evaporation coating in vacuo, chemical vapor deposition, spraying, dipping, sputtering, and/or painting. In some embodiments, a coating material can be added to a polymer mixture prior to formation of a device. If a coating material is used that has a similar melting point as the peak temperature of the mixture, it can migrate to and coat the surface of the device during manufacture. Such coating materials include certain waxes and cross-linking agents, for example. A coating may be applied as a single layer or a plurality of layers, in some embodiments. A coating may be effectively adhered directly to a device without a gap between the coating and the device (e.g., by a compress-bonding process) in some embodiments. In the latter embodiments, the coating generally is not readily peeled or removed from the surface of the device. A coating may be applied to a device using a degradable adhesive, in certain embodiments, and a coating may be attached by heating and a compress-bonding process, in some embodiments. A method for manufacturing a device herein may include first forming the coating and then forming the plastic bodies of the device, in some embodiments.

Recycled Plastics

Microtiter plates can be manufactured from any type of recycled material. In certain embodiments, the microtiter plates can be manufactured where one or more parts, or the entire device is made from recycled material and/or in combination with degradable materials. Recycled material can be plastic, cellulosic material or metal by any suitable method known for shaping plastics, polymers, wood or paper pulps and metals, including without limitation, molding, thermoforming, injection molding, and casting, for example. In some embodiments, recyclable plastics can be manufactured from any material known to one of skill in the art. In certain embodiments the recycled material can include by way of example, but is not limited to polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystyrene, acrylnitrile butadiene styrene copolymers, and bio-plastics (e.g., bio-based platform chemicals made or derived from biological materials, such as vegetable oil (e.g., canola oil), and not from petrochemicals). For example, the plastic may be recycled PET or Bio-PET (e.g., PET made from vegetable oil, and not from petrochemicals). Bio-based plastic alternatives now exist for low and high density polyethylene (LDPE/HDPE), polypropylene (PP), polyethylene teraphthalate (PET), and polyvinyl chloride (PVC). Bio-plastic alternatives can be substituted for petroleum based plastics, where suitable, in the embodiments described herein.

Bio-PET or any type of biologically or environmentally friendly PET materials can be used in the manufacturing methods and processes of the microtiter plates. Biologically or environmentally friendly materials can comprise any materials that are considered to inflict minimal or no harm on biological organisms or the environment, respectively.

Bio-PET can be produced from a wide variety of different sources. Bio-PET can be produced from any of type of plant such as algae, for example. Other biologically or environmentally friendly PET materials may be produced from other sources such as animals, inert substances, organic materials or man-made materials.

Microtiter plates described herein can be manufactured from any type of environmentally friendly, earth friendly, biologically friendly, natural, organic, carbon based, basic, fundamental, elemental material. Such materials can aid in either degradation and/or recycling of the device or parts of the device. Such materials can have non-toxic properties, aid in producing less pollutants, promote an organic environment, and further support living organisms.

In some embodiments, the polymer used to manufacture microtiter plates described herein is a biodegradable polymer. Non-limiting examples of biodegradable polymers include naturally-occurring polymers consisting of polysaccharides (e.g., starch and the like), microbial polyesters that can be degraded by the biological activities of microorganisms (e.g., polyhydroxyalkanoates and the like), conventional plastics mixed with degradation accelerators (e.g., mixtures having accelerated degradation characteristics such as photosensitizers), chemosynthetic compounds (e.g., aliphatic polyesters and the like), or specific polymer compounds and/or compositions described above.

Microtiter plate—method of manufacture

Microtiter plates currently available to the user sometimes are made by an injection molding process. Microtiter plates described herein are made by a thermoforming process. Microtiter plates described herein are configured with a low sidewall height and reduced volumetric capacity to reduce or eliminate excessive wall thinning and wall non-uniformities sometimes associated with thermoforming products that have a high W_{dd} or high draw ratio, as described above.

Thermoforming is a manufacturing process whereby a plastic sheet is heated to a pliable forming temperature, formed to a specific shape in a mold, and trimmed to create a usable product. The sheet, or “film” when referring to thinner gauges and certain material types, is heated in an oven to a high-enough temperature that it can be stretched into or onto a mold and cooled to a finished shape. In the highest expression of the technology, thermoforming offers close tolerances, tight specifications, and sharp detail. When combined with advanced finishing techniques, high-technology thermoforming results in products comparable to those formed by injection molding.

In a common method of high-volume, continuous thermoforming of thin-gauge products, plastic sheet is fed from a roll or from an extruder into a set of indexing chains that incorporate pins, or spikes, that pierce the sheet and transport it through an oven for heating to forming temperature. Alternatively, the plastic sheet sometimes can be held or clamped into a frame-like holding device, which is then transported into the heating area (e.g., oven or kiln and the like). The heated sheet is then transported into a form station where a mating mold and pressure-box close on the sheet, with vacuum then applied to remove trapped air and to pull the material into or onto the mold along with pressurized air to form the plastic to the detailed shape of the mold. Plug-assists are typically used in addition to vacuum in the case of taller, deeper-draw formed parts in order to provide the needed material distribution and thicknesses in the finished parts. After a short form cycle, a burst of reverse air pressure is actuated from the vacuum side of the mold as the form tooling opens, commonly referred to as air-eject, to break the vacuum and assist the formed parts off of, or out of, a mold. A stripper plate may also be utilized on the mold as it opens for ejection of more detailed parts or those with negative-draft, undercut areas. The sheet containing the formed parts then indexes into a trim station on the same machine, where a die cuts the parts from the remaining sheet web, or indexes into a separate trim press where the formed parts are trimmed. One of skill in the art will be aware of modifications to the described thermoforming process, or other thermoforming methods that can be used to produce equivalent microtiter plates.

Thermoforming processes generally can be used to produce products from thin gauge (sheet thicknesses less than 0.060 inches, for example) or thick gauge (sheet thicknesses greater than 0.120 inches, for example) plastic sheet. An “intermediate” thickness market, for products with a thickness that falls in the range of about 0.060 and 0.120, is currently undergoing rapid growth. Products made by thermoforming range from thin gauge product packaging and laboratory supplies to thick gauge aircraft windscreens, automobile dashboards, automobile body panels and the like. Thermoforming often offers advantages to other types of plastic forming, including but not limited to, shorter time from design to market, lower tooling costs, higher achievable tolerances, lower temperature and energy requirements with respect to injection molding and the like.

Differences in sheet thickness and polymer material will define the temperature and length of time that the plastic is heated. The plastic material typically is heated until it becomes pliable, but does not melt. One method for determining the proper temperature of the plastic to be molded is to visually or electronically identify a sag in the center of the polymer sheet, clamped for processing. The plastic sheet sometimes is held in a frame-like device while heating, to allow the pliable plastic to be contacted with the mold. The temperature at which a plastic begins to sag, is defined as the “sag point” or “sag temperature”. The pliable material begins to “bend” or “bow” downwards, sometimes aided by gravity, into the mold. In some embodiments, pressurized air can be blown at the pliable sheeting to form a larger sag depression or, if the air is blown upwards, a pressure induced “bubble” (e.g., pressure bubble), for the purposes of thinning the sheet in the central region prior to contact with the mold.

Any suitable thermoforming process can be used to produce the microtiter plates described herein. Depending on the type of thermoforming process used (e.g., vacuum forming, pressure forming, plug-assist forming, reverse-draw forming, free forming or matched-die forming), vacuum, pressurized air, plugs or combinations thereof force the pliable plastic into the mold. A vacuum can be applied to one side of the mold, and in some embodiments pressurized air from the other side of the mold can help further evacuate air on the negative pressure side and/or further force the heated plastic against the mold. In some embodiments a plug also can be used to force the heated plastic against the molding surface. Upon cooling, the thermoformed product can be released from the mold by pressurized air, or a stripping device. Final trimming and processing steps yields the final thermoformed product.

Vacuum forming and pressure forming are substantially similar processes with the exception of the air pressure used. In vacuum forming, air is evacuated from beneath the polymer material as it being placed on the mold. The vacuum formed beneath the polymer as it is placed in contact with the mold aids in stretching, and seating, the heated polymer into all the mold surfaces. The vacuum formed beneath the polymer, allows atmospheric pressure above the polymer to act in combination with the suction below the polymer to force the polymer on the mold. The vacuum is released when the plastic has cooled. In some processes, pressurized air can be used to release the product from the mold surface, the air being blown up at the product through the same vents used to evacuate the air from beneath the polymer. In certain processes, a mechanical stripper is used to release the product from the mold.

Pressure forming utilizes pressurized air, blown on the heated polymer, to aid in stretching and seating the heated polymer on the mold. A high pressure blast of air is applied quickly to the heated polymer to force the polymer against the mold. Pressure forming offers the advantages of; lower temperatures (e.g., polymer need not be as pliant, due to the high pressure air used to force the polymer into the mold), faster cycle times (e.g., less time to cool and less time to seat in mold), and better dimensional control (e.g., uniformity of thickness due to lower temperatures and less stretching). Pressure forming methods often are carried out in combination with vacuum forming and/or plug-assist forming. Pressurized air and mechanical strippers commonly are used to remove product from a molding surface in many thermoforming processes.

Plug-assist forming often is a combinatorial method used in conjunction with another method of thermoforming. Non-limiting examples of plug-assist forming include, pressure bubble plug assist forming, vacuum aided plug assist forming, and pressure aided plug assist forming. The heated polymer is partially forced into the mold using a plug. The polymer is further seated onto the mold by vacuum or pressurized air. Plugs typically are about 10% to 20% smaller in length and width than the mold. In some embodiments, the plug can include one or more features or contours found in the final product. Plugs can be made from a variety of materials with low heat conductivity and high dimensional stability (e.g., necessary in pressure assist or vacuum assist forming methods). Plug-assist forming generally offers better wall thickness uniformity than vacuum or pressure forming.

Reverse-draw thermoforming often is utilized when products with deep draws are required. The term “draw” as used with reference to thermoforming refers to a feature (e.g., well, wall, trough and the like) with a significant depth. A non-limiting example of an object with a deep draw, relative to the overall height of the object is a microtiter plate. Each well of a microtiter plate has a well wall height that is substantially the same as the overall height of the object. Forming an object with many features that have a deep draw often requires reverse-draw forming or reverse-draw forming in combination with another method (e.g., plug-assist, plug-assist and vacuum assist, combinations thereof, and the like). The reverse-draw method utilizes the “bubble” process mentioned above. The polymer sheet is heated, thinned using pressurized air, forced into the mold using vacuum, plug-assist, pressurized air or combinations thereof, and fine, detail features often necessary in products with deep draws are created.

Matched die forming is another process often used for products with fine detail. The material is heated and pressed between two matching molds. No vacuum or air pressure is applied during the forming process. The material is kept under pressure in the matching molds until completely cooled, thereby producing the desired product. Matched die forming offers increased uniformity in stretching and/or thinning of the formed features.

In certain embodiments, microtiter plates described herein can be prepared by a process that comprises contacting a mold with a polymer sheet and deforming the sheet on the mold, whereby a microtiter plate is formed from the sheet; where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick. In some embodiments, a process for preparing a microtiter plate that comprises contacting a mold with a polymer sheet and deforming the sheet on the mold, whereby a microtiter plate is formed from the sheet where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick

The features formed in the thermoformed polymer sheet are generated by contacting a heated polymer sheet with a mold comprising the desired three dimensional features. Molds can be made from a variety of materials including, but not limited to, machined aluminum, cast aluminum, composite materials and the like, for example. In some embodiments, the mold has surfaces that form three-dimensional surfaces of the microtiter plate from the sheet. Molds sometimes are negative molds (e.g., concave cavity) and sometimes are positive molds (e.g., convex shape). For products made using a negative mold, the exterior surface has the exact surface contour of the mold cavity. The inside surface often is an approximation of the contour and possesses a finish corresponding to that of the starting sheet. By contrast, for products made using a positive mold, the interior surface features are substantially identical to that of the convex mold; and its outside surface is an approximation. The use of positive or negative molds can be an important consideration in thermoforming due to the differences in material stretching and thinning achieved with each mold type. In matched die forming, a positive and a negative mold are used, thereby producing products with surface contours and finish detail that is identical to both mold pieces.

In certain embodiments, the sheet often is contacted with a mold via vacuum, and/or pressurized air. In some embodiments, the sheet can be contacted with a mold in the absence of applied vacuum or air pressure. In some embodiments, the mold and/or environment around the mold may be at a reduced temperature, relative to the temperature of the heated polymer material, to promote rapid, efficient cooling of the formed products. The temperature to which the polymer material is heated is dependent on the chemical composition and thickness of the polymer, but typically is in a range around the sag point determined for that combination of polymer composition and sheet thickness. The temperature to which polymers suitable for use with embodiments described herein are heated often are in the range of about 120 degrees Celsius (C) and about 150 degrees C., about 120 degrees C. and about 160 degrees C., about 120 degrees C. and about 170 degrees C., about 120 degrees C. and about 180 degrees C., about 120 degrees C. and about 190 degrees C., about 120 degrees C. and about 200 degrees C., about 120 degrees C. and about 210 degrees C., about 120 degrees C. and about 220 degrees C. and about 110 degrees C. and about 230 degrees C. (e.g., about 110 degrees C., about 120 degrees C., about 130 degrees C., about 140 degrees C., about 150 degrees C., about 160 degrees C., about 170 degrees C., about 180 degrees C., about 190 degrees C., about 200 degrees C., about 210 degrees C., about 220 degrees C., and about 230 degrees C.).

Microtiter plate—Methods of use

The microtiter plates described herein often are used to hold, store, transport, manipulate or dispense liquids, reagents, or samples, in some embodiments. In certain embodiments, the microtiter plates described herein can be used in conjunction with fluid handling devices to effect purification and/or isolation schemes. In some embodiments, the microtiter plates described herein can be used in a method for manipulating a reagent in a microtiter plate that comprises introducing a reagent to a microtiter plate and removing the reagent from the microtiter plate, where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick. Frequently, liquid dispensing devices (e.g., manual or automated, single or multi-channel pipettors) can be used to introduce and/or remove reagents, liquids or samples to and/or from a microtiter plate as described herein. One of skill will be familiar with the operation of manual and/or automated liquid dispensing devices that can be utilized with microtiter plates described herein.

Microtiter plates described herein sometimes are used in conjunction with fluid handling devices to enhance the uses of microtiter plates. The use of additional fluid handling devices can be incorporated into the general use methods described above. For example a solid support can be used with a microtiter plate to remove nucleic acids above or below a threshold range, such that subsequent pipetting steps utilize a partially purified nucleic acid reagent. The partially purified nucleic acid reagent can be prepared by introducing a reagent to a microtiter plate that has an added or incorporated solid support, followed by (i) removal of the solid support, thereby leaving a partially purified liquid which can be removed to other containers, or (ii) removal of the liquid, thereby leaving a partially purified sample that can be reintroduced to a second liquid or reagent.

The microtiter plates described herein sometimes are used in conjunction with devices with optical sensors that often are useful for absorbance detection, luminescence detection, fluorescence intensity detection, time-resolved fluorescence (TRF) measurement, and/or fluorescence polarization measurement, microtiter plate readers for example. Microtiter plate readers also are referred to as microplate readers or plate readers. Microtiter plate readers are laboratory instruments useful for detecting biological, chemical or physical events of samples in microtiter plates. Microtiter plate readers are widely used in basic research, drug discovery, bioassay validation, quality control and manufacturing processes.

In some embodiments, the microtiter plates described herein can be used in conjunction with devices equipped with optical sensors that detect emitted light and fluid handling devices, robotic devices and many laboratory or clinical procedures to effect purification, isolation, identification, and/or diagnostic schemes. The use of microtiter plate readers, or microtiter plate readers and fluid handling devices can be incorporated into the general use methods described above. In certain embodiments, microtiter plates described herein can be used in a method for measuring the optical transmittance of a sample liquid in a microtiter plate that comprises contacting a microtiter plate containing the sample liquid with light and measuring the amount of light transmitted through the sample liquid using a suitable light measurement device (e.g., microtiter plate reader), where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick. In some embodiments, microtiter plates described herein can be used in a method for measuring the optical absorbance of a sample liquid in a microtiter plate that comprises contacting a microtiter plate containing the sample liquid with light and measuring the amount of light absorbed by the sample liquid using a suitable light measurement device (e.g., microtiter plate reader), where the microtiter plate comprises a plate, sidewalls extending from the plate perimeter, and a plurality of wells, each including a well aperture coextensive with the plate, a well wall extending from the plate and a well bottom, where the plate, sidewalls, well wall and well bottom are constructed from a polymer and the plate, sidewalls, well wall and well bottom are about 0.00085 to 0.023 inches thick.

In some embodiments, a reference standard liquid can be utilized to determine the amount of light transmitted though the sample liquid. In some embodiments, a reference standard liquid can be utilized to determine the amount of light absorbed by the sample liquid. In certain embodiments, the polymer used is treated to enhance the ability to measure light transmittance. In certain embodiments, the polymer used is treated to enhance the ability to measure light absorbance. In some embodiments, the light is measured as fluorescence.

### EXAMPLES

The examples set forth below illustrate certain embodiments and do not limit the invention.
A1. A microtiter plate, comprising:
   a plate,
   sidewalls extending from the plate perimeter, and
   a plurality of wells, each including a well aperture coextensive with the plate, a well wall extending from the plate and a well bottom, wherein:
      the plate, sidewalls, well wall and well bottom are constructed from a polymer; and
      the plate, sidewalls, well wall and well bottom are about 0.00085 to 0.023 inches thick.
B1. A microtiter plate prepared by a process, comprising:
   contacting a mold with a polymer sheet; and
   deforming the sheet on the mold, whereby a microtiter plate is formed from the sheet;
   wherein the microtiter plate comprises:
      a plate,
      sidewalls extending from the plate perimeter, and
      a plurality of wells, each including a well aperture coextensive with the plate, a well wall extending from the plate and a well bottom, wherein:
         the plate, sidewalls, well wall and well bottom are constructed from a polymer; and
         the plate, sidewalls, well wall and well bottom are about 0.00085 to 0.023 inches thick.
C1. A process for preparing a microtiter plate, comprising
   contacting a mold with a polymer sheet; and
   deforming the sheet on the mold, whereby a microtiter plate is formed from the sheet;
   wherein the microtiter plate comprises:
      a plate,
      sidewalls extending from the plate perimeter, and
      a plurality of wells, each including a well aperture coextensive with the plate, a well wall extending from the plate and a well bottom, wherein:
         the plate, sidewalls, well wall and well bottom are constructed from a polymer; and
         the plate, sidewalls, well wall and well bottom are about 0.00085 to 0.023 inches thick.
D1. A method for manipulating a reagent in a microtiter plate, comprising;
   introducing a reagent to a microtiter plate; and
   removing the reagent from the microtiter plate, wherein the microtiter plate comprises:
      a plate,
      sidewalls extending from the plate perimeter, and
      a plurality of wells, each including a well aperture coextensive with the plate, a well wall extending from the plate and a well bottom, wherein:
         the plate, sidewalls, well wall and well bottom are constructed from a polymer; and
         the plate, sidewalls, well wall and well bottom are about 0.00085 to 0.023 inches thick.
E1. The microtiter plate of any one of embodiments A1-D1, wherein the sidewall bottom edges form a footprint configured to contact an automated dispensing device.
E2. The microtiter plate of any one of embodiments A1-E1, wherein the sidewalls comprise a substantially vertical surface.
E3. The microtiter plate of any one of embodiments A1-E2, further comprising four sidewalls.
E4. The microtiter plate of any one of embodiments A1-E3, wherein the plate and sidewalls are coextensive.
E5. The microtiter plate of any one of embodiments A1-E4, wherein the plate and wells are coextensive.
E6. The microtiter plate of any one of embodiments A1-E5, wherein the sidewall edges comprise a flange angled with respect to the base of the sidewalls.
E7. The microtiter plate of embodiment E6, wherein the sidewall flange angle is in the range of about 91 degrees to about 95 degrees with respect to the base of the sidewalls.
E7.1 The microtiter plate of embodiment E7, wherein the sidewall flange angle is about 93 degrees with respect to the base of the sidewalls.
E8. The microtiter plate of any one of embodiments A1-E7, wherein the sidewall bottom edge and/or sidewall flange are coplanar with the well base outer surface.
E9. The microtiter plate of any one of embodiments A1-E8, wherein the sidewalls have a wall height in the range of about 0.25 to 0.45 inches.
E10. The microtiter plate of any one of embodiments A1-E9, further comprising a sidewall to plate draw ratio in the range of about 1:0.525 to about 1:1.
E11. The microtiter plate of any one of embodiments A1-E10, wherein the plate comprises 96 wells.
E12. The microtiter plate of embodiment E11, wherein the well has a volume in the range of about 175 and 225 microliters.
E13. The microtiter plate of embodiment E11, wherein the wells further comprise a well center to well center distance in the range of about 0.340 inches to about 0.360 inches +/− about 0.028 inches.
E14. The microtiter plate of embodiment E11, further comprising a well aperture to well height draw ratio of about 0.7 to about 1.75.
E15. The microtiter plate of any one of embodiments A1-E9, wherein the plate comprises 384 wells.
E16. The microtiter plate of embodiment E15, wherein the well has a volume in the range of about 10 microliters and about 90 microliters.
E17. The microtiter plate of embodiment E15, wherein the wells further comprise a well center to well center distance in the range of about 0.172 inches to about 0.182 inches +/− about 0.028 inches.
E18. The microtiter plate of embodiment E15, further comprising a well aperture to well height draw ratio of about 0.70 to about 1.15.
E19. The microtiter plate of any one of embodiments A1-E9, wherein the plate comprises 1536 wells.
E20. The microtiter plate of embodiment E19, wherein the well has a volume in the range of about 2 microliters and about 8 microliters.
E21. The microtiter plate of embodiment E19, wherein the wells further comprise a well center to well center distance in the range of about 0.085 inches to about 0.095 inches +/− about 0.020 inches.
E22. The microtiter plate of embodiment E19, further comprising a well aperture to well height draw ratio of about 0.70 to about 1.15.
E23. The microtiter plate of any one of embodiments A1-E9, wherein the plate comprises 6144 wells.
E24. The microtiter plate of embodiment E23, wherein the well has a volume in the range of about 1 microliter and about 4 microliters.
E25. The microtiter plate of embodiment E23, wherein the wells further comprise a well center to well center distance in the range of about 0.040 inches to about 0.050 inches.
E26. The microtiter plate of embodiment E23, further comprising a well aperture to well height draw ratio of about 0.70 to about 1.15.
E27. The microtiter plate of any one of embodiments A1-E26, wherein the well cross-sectional shape is chosen from a circle, a square, a triangle, a polygon.
E28. The microtiter plate of any one of embodiments A1-E27, wherein the well bottom is flat.
E29. The microtiter plate of any one of embodiments A1-E27, wherein the well bottom is round.
E30. The microtiter plate of any one of embodiments A1-E27, wherein the well bottom is stepped.
E31. The microtiter plate of any one of embodiments A1-E27, wherein the well bottom is an inverted cone shape.
E32. The microtiter plate of any one of embodiments A1-E31, wherein the polymer is selected from polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystryrene, acrylnitrile butadiene styrene copolymers, crosslinked polysiloxanes, polyurethanes, (meth)acrylate-based polymers, cellulose and cellulose derivatives, polycarbonates, ABS, tetrafluoroethylene polymers, plastics with higher flow and lower viscosity, a combination of two or more of the foregoing, corresponding copolymers and the like.
E33. The microtiter plate of any one of embodiments A1-E31, wherein the polymer is a biodegradable polymer.

E34. The microtiter plate of embodiment E33, wherein the biodegradable polymer is selected from (a) naturally-occurring polymers consisting of polysaccharides (e.g., starch and the like); (b) microbial polyesters that can be degraded by the biological activities of microorganisms (e.g., polyhydroxyalkanoates and the like); (c) conventional plastics mixed with degradation accelerators (e.g., mixtures having accelerated degradation characteristics such as photosensitizers); and (d) chemosynthetic compounds (e.g., aliphatic polyesters and the like).
F1. A method for measuring the optical transmittance of a sample liquid in a microtiter plate comprising:
   contacting a microtiter plate containing the sample liquid with light; and
   measuring the amount of light transmitted through the sample liquid using a suitable light measurement device, wherein the microtiter plate comprises:
      a plate,
      sidewalls extending from the plate perimeter, and
      a plurality of wells, each including a well aperture coextensive with the plate, a well wall extending from the plate and a well bottom, wherein:
         the plate, sidewalls, well wall and well bottom are constructed from a polymer and;
         the plate, sidewalls, well wall and well bottom are about 0.00085 to 0.023 inches thick.
F2. A method for measuring the optical absorbance of a sample liquid in a microtiter plate comprising:
   contacting a microtiter plate containing the sample liquid with light; and
   measuring the amount of light absorbed by the sample liquid using a suitable light
   measurement device, wherein the microtiter plate comprises:
      a plate, sidewalls extending from the plate perimeter, and
      a plurality of wells, each including a well aperture coextensive with the plate, a well wall extending from the plate and a well bottom, wherein:
         the plate, sidewalls, well wall and well bottom are constructed from a polymer; and
         the plate, sidewalls, well wall and well bottom are about 0.00085 to 0.023 inches thick.
F3. The method of embodiment F1, wherein a reference standard liquid can be utilized to determine the amount of light transmitted though the sample liquid.
F4. The method of embodiment F2, wherein a reference standard liquid can be utilized to determine the amount of light absorbed by the sample liquid.
F5. The method of embodiment F1, wherein the polymer used is treated to enhance the ability to measure light transmittance.
F6. The method of embodiment F2, wherein the polymer used is treated to enhance the ability to measure light absorbance.
F7. The method of any one of embodiments F1-F6, wherein the light used to contact the microtiter plate is visible light.
F8. The method of any one of embodiments F1-F7, wherein the light used to contact the microtiter plate is ultraviolet light (UV) light.
F9. The method of any one of embodiments F1-F8, wherein the light is measured as fluorescence.

The entirety of each patent, patent application, publication and document referenced herein hereby is incorporated by reference. Citation of the above patents, patent applications, publications and documents is not an admission that any of the foregoing is pertinent prior art, nor does it constitute any admission as to the contents or date of these publications or documents.

Modifications may be made to the foregoing without departing from the basic aspects of the invention. Although the invention has been described in substantial detail with reference to one or more specific embodiments, those of ordinary skill in the art will recognize that changes may be made to the embodiments specifically disclosed in this application, yet these modifications and improvements are within the scope and spirit of the invention.

The invention illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation, and use of such terms and expressions do not exclude any equivalents of the features shown and described or portions thereof, and various modifications are possible within the scope of the invention claimed. The term “a” or “an” can refer to one of or a plurality of the elements it modifies (e.g., “a reagent” can mean one or more reagents) unless it is contextually clear either one of the elements or more than one of the elements is described. The term “about” as used herein refers to a value within 10% of the underlying parameter (i.e., plus or minus 10%), and use of the term “about” at the beginning of a string of values modifies each of the values (i.e., “about 1, 2 and 3” refers to about 1, about 2 and about 3). For example, a weight of “about 100 grams” can include weights between 90 grams and 110 grams. Further, when a listing of values is described herein (e.g., about 50%, 60%, 70%, 80%, 85% or 86%) the listing includes all intermediate and fractional values thereof (e.g., 54%, 85.4%). Thus, it should be understood that although the present invention has been specifically disclosed by representative embodiments and optional features, modification and variation of the concepts herein disclosed may be resorted to by those skilled in the art, and such modifications and variations are considered within the scope of this invention.

Certain embodiments of the invention are set forth in the claim(s) that follow(s).

What is claimed is:

1. A method for preparing a 96 well microtiter plate, comprising:
deforming a polymer sheet on a mold by a thermoforming process, whereby a microtiter plate is formed from the sheet; wherein the microtiter plate comprises:
a plate,
sidewalls extending from the plate perimeter, and
96 wells, each including a well aperture coextensive with the plate, a well wall extending from the plate and a well bottom, wherein each well comprises a well depth to diameter ratio of about 0.50 to about 1.75,
which plate, sidewalls, well wall and well bottom are about 0.00085 to 0.023 inches thick,
which sidewalls have a wall height of about 0.30 to 0.50 inches,
which wells have a volume of about 175 to 225 microliters, and
which sidewall height and well volume provide for well walls of substantially uniform thickness.

2. The method of claim 1, wherein the sidewall bottom edges form a footprint configured to contact an automated dispensing device.

3. The method of claim 1, wherein the sidewalls comprise a substantially vertical surface.

4. The method of claim 1, wherein the plate and sidewalls are coextensive.

5. The method of claim 1, wherein the sidewall edges comprise a flange angled with respect to the base of the sidewalls.

6. The method of claim 5, wherein the sidewall flange angle is about 93 degrees with respect to the base of the sidewalls.

7. The method of claim 1, wherein a well bottom is flat.

8. The method of claim 1, wherein a well bottom is round.

9. The method of claim 1, wherein the polymer is selected from polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystryrene, acrylnitrile butadiene styrene copolymers, crosslinked polysiloxanes, polyurethanes, (meth)acrylate-based polymers, cellulose and cellulose derivatives, polycarbonates, ABS, tetrafluoroethylene polymers, plastics with higher flow and lower viscosity, a combination of two or more of the foregoing, corresponding copolymers and the like.

10. The method of claim 1, wherein the polymer is a biodegradable polymer.

11. A method for preparing a 384 well microtiter plate, comprising;
deforming a polymer sheet on a mold by a thermoforming process, whereby a microtiter plate is formed from the sheet; wherein the microtiter plate comprises:
a plate,
sidewalls extending from the plate perimeter, and
384 wells, each including a well aperture coextensive with the plate, a well wall extending from the plate and a well bottom, wherein each well comprises a well depth to diameter ratio of about 0.70 to about 1.15,
which plate, sidewalls, well wall and well bottom are about 0.00085 to 0.023 inches thick,
which sidewalls have a wall height of about 0.30 to 0.50 inches,
which wells have a volume of about 10 to 90 microliters, and
which sidewall height and well volume provide for well walls of substantially uniform thickness.

12. The method of claim 11, wherein the sidewall bottom edges form a footprint configured to contact an automated dispensing device.

13. The method of claim 11, wherein the sidewalls comprise a substantially vertical surface.

14. The method of claim 11, wherein the plate and sidewalls are coextensive.

15. The method of claim 11, wherein the sidewall edges comprising a flange angled with respect to the base of the sidewalls.

16. The method of claim 15, wherein the sidewall flange angle is about 93 degrees with respect to the base of the sidewalls.

17. The method of claim 11, wherein a well bottom is flat.

18. The method of claim 11, wherein a well bottom is round.

19. The method of claim 11, wherein the polymer is selected from polypropylene (PP), polyethylene (PE), high-density polyethylene, low-density polyethylene, polyethylene teraphthalate (PET), polyvinyl chloride (PVC), polyethylenefluoroethylene (PEFE), polystyrene (PS), high-density polystryrene, acrylnitrile butadiene styrene copolymers, crosslinked polysiloxanes, polyurethanes, (meth)acrylate-based polymers, cellulose and cellulose derivatives, polycarbonates, ABS, tetrafluoroethylene polymers, plastics with higher flow and lower viscosity, a combination of two or more of the foregoing, corresponding copolymers and the like.

20. The method of claim 11, wherein the polymer is a biodegradable polymer.
